(19) United States
(12) Patent Application Publication
(10) Pub. No.: US 2024/0403546 A1
(43) Pub. Date: Dec. 5, 2024

(54) AUTOMATIC TEXT RECOGNITION WITH TABLE PRESERVATION

(71) Applicant: Apple Inc., Cupertino, CA (US)

(72) Inventors: Hanna RAGNARSDÓTTIR, Schlieren (CH); Thomas DESELAERS, Zurich (CH); Francisco ALVARO MUNOZ, Zurich (CH); Ryan S. DIXON, Redwood City, CA (US)

(21) Appl. No.: 18/373,962

(22) Filed: Sep. 27, 2023

Related U.S. Application Data
(60) Provisional application No. 63/470,835, filed on Jun. 3, 2023.

(51) Int. Cl. G06F 40/177; G06T 7/70; G06V 30/146; G06V 30/412

(52) U.S. Cl. CPC G06F 40/177; G06T 7/70; G06V 30/147; G06V 30/412

(57) ABSTRACT

Aspects of the subject technology include identifying one or more portions of a data object that include a table by providing the data object to a table detection model, determining a structure of the table by providing the one or more portions of the data object to a table structure recognition model, generating a virtual table based on the determined structure of the table, the virtual table including an indication of at least one of one or more rows, one or more columns, or one or more cells corresponding to the table, mapping text from the one or more portions of the data object to corresponding cells of the virtual table, and performing a process with the virtual table.

### CROSS-REFERENCE TO RELATED APPLICATIONS

The present application claims the benefit of U.S. Provisional Patent Application Ser. No. 63/470,835, entitled “AUTOMATIC TEXT RECOGNITION WITH TABLE PRESERVATION,” filed Jun. 3, 2023, which is hereby incorporated herein by reference in its entirety and made part of the present U.S. Utility Patent Application for all purposes.

### TECHNICAL FIELD

The present description generally relates to processing text data on electronic devices, including text data from data objects, such as image files.

### BACKGROUND

An electronic device such as a laptop, tablet, or smartphone, may be configured to access text data via a variety of formats, including images. Images may include text data that may be recognized by the electronic device.

### BRIEF DESCRIPTION OF THE DRAWINGS

Certain features of the subject technology are set forth in the appended claims. However, for the purpose of explanation, several implementations of the subject technology are set forth in the following figures.

FIG. 1 illustrates an example network environment, in accordance with one or more implementations.

FIG. 2 depicts an example electronic device that may implement the subject methods and systems, in accordance with one or more implementations.

FIG. 3 depicts an example electronic document, in accordance with one or more implementations.

FIG. 4 depicts an example of identifying text data in the electronic document, in accordance with one or more implementations.

FIG. 5 depicts the example electronic document having bounding boxes for each line of text, in accordance with one or more implementations.

FIG. 6 depicts an example of generating a virtual table from a portion of the electronic document, in accordance with one or more implementations.

FIG. 7 depicts an example of mapping text data to the virtual table, in accordance with one or more implementations.

FIG. 8 depicts an example of copying text data including a table, in accordance with one or more implementations.

FIG. 9 depicts an example of pasting copied text data, in accordance with one or more implementations.

FIG. 10 depicts a flow diagram of an example process for processing text data including a table, in accordance with one or more implementations.

FIG. 11 depicts an example electronic system with which aspects of the present disclosure may be implemented, in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

When copying a table from one electronic document to another, a user may manually transcribe the table data into a new table, which may be time-consuming and prone to errors. Although optical character recognition (“OCR”) systems may recognize text within images, such as text within a table, the OCR systems may fail to maintain the structure of such a table, and instead may produce a bulk of unstructured text that lacks the context provided by the table. The present disclosure relates to an improved processing of selected text that includes a table. As a non-limiting example, the present disclosure can be used to improve a copy/paste operation, a translation operation, a dictation operation, and/or any other operation that may utilize text data in table format and/or text data that includes a table.

The present disclosure employs a machine learning approach to recognize, extract, and reconstruct a table directly from images or other data objects, maintaining the table's original structure. The subject technology simplifies the process of copying tables from one source to another and eliminates the need for manual transcription, thereby saving time and reducing errors. Aspects of the subject technology include using a machine learning model trained to recognize text and tables within images, including table orientation, making the subject technology versatile for a range of scenarios.

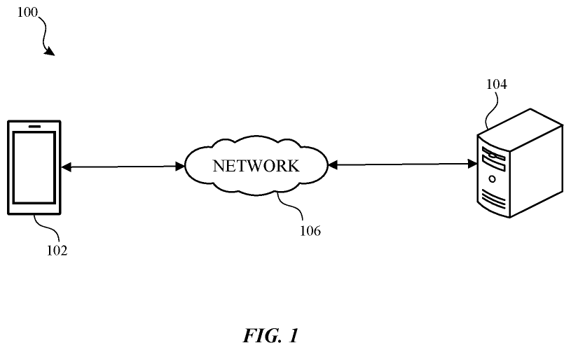

FIG. 1 illustrates an example network environment 100, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided. In one or more implementations, the subject methods may be performed on the electronic device 102 without use of the network environment 100.

The network environment 100 may include an electronic device 102 and one or more servers (e.g., a server 104). The network 106 may communicatively (directly or indirectly) couple the electronic device 102 and the server 104. In one or more implementations, the network 106 may be an interconnected network of devices that may include, or may be communicatively coupled to, the Internet. For explanatory purposes, the network environment 100 is illustrated in FIG. 1 as including the electronic device 102 and the server 104; however, the network environment 100 may include any number of electronic devices and/or any number of servers communicatively coupled to each other directly or via the network 106.

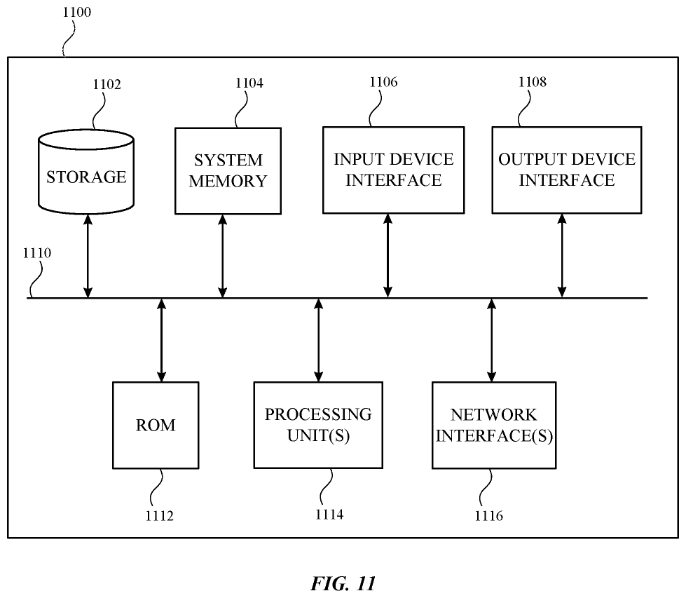

The electronic device 102 may be, for example, a desktop computer, a portable computing device such as a laptop computer, a smartphone, a peripheral device (e.g., a digital camera, headphones), a tablet device, a wearable device such as a watch, a band, and the like, or any other appropriate device that includes, for example, one or more wireless interfaces, such as WLAN radios, cellular radios, Bluetooth radios, Zigbee radios, near field communication (NFC) radios, and/or other wireless radios. In one or more implementations, the electronic device 102 may include a text recognition/detection module (and/or circuitry), a table recognition/detection module (and/or circuitry), and one or more applications. In FIG. 1, by way of example, the electronic device 102 is depicted as a smartphone. The electronic device 102 may be, and/or may include all or part of, the electronic system discussed below with respect to FIG. 11. In one or more implementations, the electronic device 102 may include a camera and a microphone and may generate and/or provide data (e.g., images or audio) for accessing (e.g., identifying) text data for processing (e.g., via a processor or the server 104).

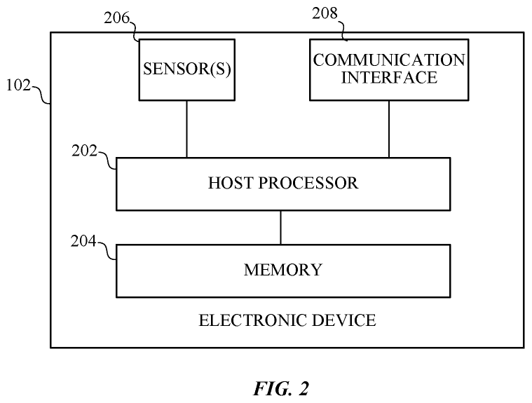

FIG. 2 depicts an electronic device 102 that may implement the subject methods and systems, in accordance with one or more implementations. For explanatory purposes, FIG. 2 is primarily described herein with reference to the electronic device 102 of FIG. 1. However, this is merely illustrative, and features of the electronic device of FIG. 2 may be implemented in any other electronic device for implementing the subject technology (e.g., the server 104). Not all of the depicted components may be used in all implementations, however, and one or more implementations may include additional or different components than those shown in FIG. 2. Variations in the arrangement and type of the components may be made without departing from the spirit or scope of the claims as set forth herein. Additional components, different components, or fewer components may be provided.

The electronic device 102 may include one or more of a host processor 202, a memory 204, one or more sensor(s) 206, and/or a communication interface 208. The host processor 202 may include suitable logic, circuitry, and/or code that enable processing data and/or controlling operations of the electronic device 102. In this regard, the host processor 202 may be enabled to provide control signals to various other components of the electronic device 102. The host processor 202 may also control transfers of data between various portions of the electronic device 102. The host processor 202 may further implement an operating system or may otherwise execute code to manage operations of the electronic device 102.

The memory 204 may include suitable logic, circuitry, and/or code that enable storage of various types of information such as received data, generated data, code, and/or configuration information. The memory 204 may include, for example, random access memory (RAM), read-only memory (ROM), flash, and/or magnetic storage. The memory 204 may store machine-readable instructions for performing methods described herein. In one or more implementations, the memory 204 may store text data (e.g., as provided by the server 104). The memory 204 may further store portions of text data for intermediate storage (e.g., in buffers) as the text data is being processed.

The sensor(s) 206 may include one or more microphones and/or cameras. The microphones may obtain audio signals corresponding to text data. The cameras may be used to obtain image files corresponding to text data (e.g., text formatted into one or more tables). For example, the cameras may obtain images of an object having text (e.g., text formatted into one or more tables), which may be processed into text data that can be utilized by the host processor 202, such as for a copy/paste operation.

The communication interface 208 may include suitable logic, circuitry, and/or code that enables wired or wireless communication, such as between the electronic device 102 and the server 104. The communication interface 208 may include, for example, one or more of a Bluetooth communication interface, an NFC interface, a Zigbee communication interface, a WLAN communication interface, a USB communication interface, a cellular interface, or generally any communication interface.

In one or more implementations, one or more of the host processor 202, the memory 204, the sensor(s) 206, the communication interface 208, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

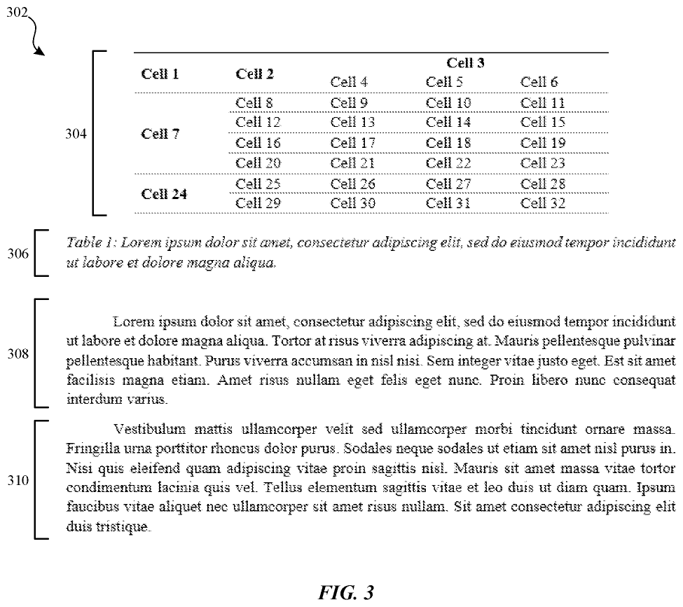

FIG. 3 depicts an example electronic document 302 (which is also referred to herein as “document” 302), in accordance with one or more implementations. In some examples, the document 302 may instead be a file, photo, video frame, or any other data object that includes text data. The document 302 may include a table 304 and paragraphs 306-310, as well as non-text content (e.g., images, charts, and the like). The table 304 may include one or more cells (e.g., cells 1-32). One or more of the cells may be merged. For example, cell 7 merges four cells spanning the height of cells 8, 12, 16, and 20; similarly, cell 3 merges three cells spanning the width of cells 4, 5, and 6.

The table 304 and paragraphs 306-310 may each include one or more lines of text data. For example, table 304 includes text data that reads ‘cell 1,’ ‘cell 2’, and so on, and for purposes of discussion, the text data of the table 304 also represent the cell structure of the table; however, this may not be the case in every implementation. As another example, paragraph 306 begins with “Table 1,” paragraph 308 begins with “Lorem ipsum,” and paragraph 310 begins with “Vestibulum mattis.”

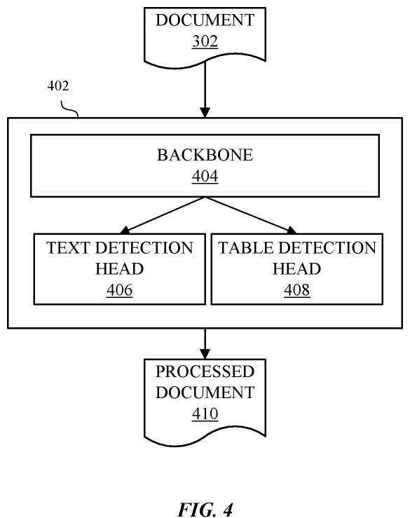

FIG. 4 depicts an example of identifying text data in the document 302, in accordance with one or more implementations. The document 302 may be provided to a machine learning model 402 configured to perform text detection and table detection. The machine learning model 402 may be a convolutional neural network (CNN) comprising a backbone network 404 and multiple network heads (e.g., text detection head 406, table detection head 408, and possibly additional networks heads, such as a list detection head, an outline detection head, and the like). The machine learning model 402 may utilize a form of transfer learning where a large model (e.g., the backbone network 404) is used as the starting point and additional networks (e.g., the network heads) are trained for particular tasks.

The backbone network 404 may be an initial feature extractor. The backbone network 404 may be a CNN configured for processing data objects, such as images. For example, the backbone network 404 may be built upon established architectures like ResNet, DenseNet, EfficientNet, MobileNet, and the like, which can extract features from data objects (e.g., images). The purpose of the backbone network 404 may be to capture and encode visual features present in the input data object.

The network heads (e.g., text detection head 406 and table detection head 408), connected to the backbone network 404, may be smaller than the backbone network 404 and task specific. The network heads may be fine-tuned to detect specific objects or patterns in images, such as text with respect to the text detection head 406 and tables with respect to the table detection head 408.

For example, the text detection head 406 may be responsible for identifying and detecting text regions within the input data object. It may receive the encoded features from the backbone network 404 and further process the features through additional layers specific to text detection tasks. These layers may include convolutional, pooling, and fully connected layers, among other types of layers. The text detection head 406 may focus on detecting and extracting textual information from the input data object, analyzing it on a character or word level.

As another example, the table detection head 408 may be designed to identify regions within the input data object that are likely to contain tables. The table detection head 408 may receive the same encoded features from the backbone network 404 as the text detection head 406. However, the layers in the table detection head 408 may be specifically trained to analyze the visual patterns and structures typically associated with tables. The table detection head 408 may examine the pixel-level likelihood of a data object region being part of a table.

In the training phase, the machine learning model 402, including the backbone network 404 and the text detection head 406, may be initially trained. Once the text detection head 406 is trained, the table detection head 408 may be trained while the rest of the network (e.g., the backbone network 404 and the text detection head 406) may be frozen, effectively fine-tuning the machine learning model 402 for table detection without affecting the accuracy of the text detection or adding significant computation overhead. For example, the machine learning model 402 may be trained using a training dataset that includes different types and forms of tables that may be included in different electronic documents, images, phots, and the like.

This modular approach enables the machine learning model 402 to leverage the power of a large, resource-intensive network (the backbone network 404) while preserving the flexibility and specificity of smaller networks (the heads). It also mitigates the need to train several large, separate models for each task, leading to computational efficiency and improved performance.

The machine learning model 402 may provide outputs from the text detection head 406 and/or the table detection head 408 in the form of a processed version of the input document 302 (e.g., the processed electronic document 410, also to as “document” 410). For text detection, the output could be in the form of recognized characters or words, along with their spatial locations in the document 302. The output may include information such as the recognized text content, its location within the document 302, confidence scores indicating the level of certainty of the text detection head 406, and the like. Regarding table detection head 408, the output may include the likelihood of each pixel in the image belonging to a region likely to include a table and would thus be a candidate for further processing.

In some examples, the text data of the table 304 may be determined to be part of a table 304 based on semantic information and/or geometric information of the text data. The semantic information may include, for example, punctuation, symbols, capitalization, a word count, part of speech tags (e.g., noun, verb, adjective, and the like as determined by natural language processing part of speech tagging algorithm), and/or any other information relating to the semantics of the text data. For example, lack of punctuation may indicate the text data is part of the table 304. The geometric information may include line starting location, line height, line spatial orientation, line length, line spacing, and/or any other information relating to the geometry of lines. The machine learning model 402 may be trained with text data encompassed by bounding boxes where shorter bounding boxes, for example, may be indicative of text data in a table (e.g., table 304) whereas longer bounding boxes in close proximity to each other may be indicative of text data in a paragraph (e.g., paragraphs 306-310).

In some examples, the text detection and table detection tasks performed by the machine learning model 402 may also or instead be performed by separate machine learning models.

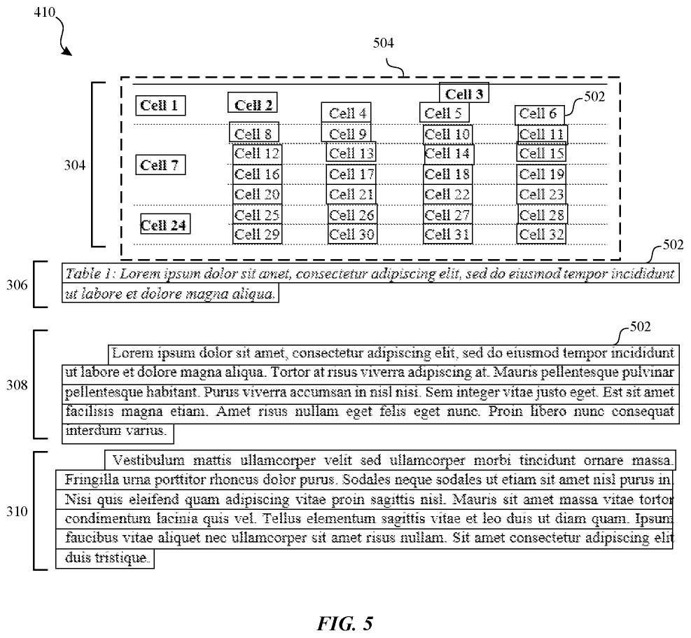

FIG. 5 depicts the example document 410 having bounding boxes, in accordance with one or more implementations. The output of the text detection head 406 of the machine learning model 402 may include one or more text bounding boxes 502 encompassing one or more lines of text (e.g., individual lines and/or paragraphs). The machine learning model 402 (e.g., the text detection head 406) may be trained on a dataset including a large number of data objects (e.g., images) where the regions of interest containing text are annotated. The annotations may be bounding boxes and/or pixel-level masks indicating the location of the text within the data object.

The output of the table detection head 408 of the machine learning model 402 may include one or more table bounding boxes 504 encompassing one or more tables (e.g., the table 304). The table detection head 408 may be trained on a dataset including a large number of images where the regions of interest containing tables are annotated. The annotations could be bounding boxes indicating the location of the table within the data object (e.g., image). The annotations may be bounding boxes and/or pixel-level masks indicating the location of the table 304 within the data object. The dataset may include a variety of tables include tables with and without cell borders.

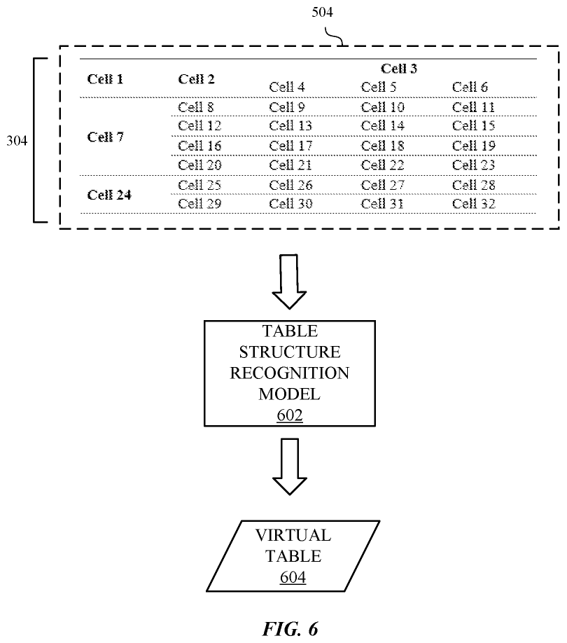

FIG. 6 depicts an example of generating a virtual table 604 from a portion of the document 410, in accordance with one or more implementations. A table structure recognition model 602 may be configured to generate a programmatic representation of the table (e.g., such as in HTML, XML, or any other computer-readable language) that can be used to reconstruct the table 304 as a virtual table 604.

The input to the table structure recognition model 602 may include a cropped portion of the document 410 that was determined to likely include the table 304. The cropped portion may correspond to the table bounding box 504 and may include the table 304 itself along with any surrounding context that may be used for proper interpretation and reconstruction of the table 304.

The table structure recognition model 602 may be configured to analyze the input portion of the document 410 and generate a programmatic representation of the table 304 as a virtual table 604. The table structure recognition model 602 may be implemented using various techniques, such as computer vision (e.g., to identify geometric features of the table 304) and natural language processing (e.g., to identify semantic features of the table 304). The table structure recognition model 602 may be trained with a dataset including data objects containing tables. For example, the table structure recognition model 602 may be trained using a training dataset that includes different types and forms of tables that may be included in different electronic documents, images, photos, and the like. The training dataset may contain tables with varying complexities such as different numbers of rows and columns, different cell sizes, tables with and without grid lines, tables with merged cells, and the like. Furthermore, the dataset may also include negative examples, such as images without any tables, to help the model learn to discern tables from non-table elements.

The table structure recognition model 602 may process the input portion of the document 410 through various computer vision techniques including preprocessing steps such as image enhancement, noise removal, and normalization to optimize the input portion for subsequent analysis. Additionally, feature extraction methods may be employed by the table structure recognition model 602 to identify geometric features of the table 304, such as lines, cells (e.g., merged and/or un-merged cells), headers, and/or contents thereof.

For example, when the table structure recognition model 602 receives as input the portion of the document 410, the table structure recognition model 602 may determine the size of the table based on the size of the table bounding box 504. The table structure recognition model 602 may then determine the boundaries of the cells within the table 304 via edge detection techniques to find visible cell boundaries and/or via clustering of text positions to predict the location of absent/faint cell boundaries. The table structure recognition model 602 may then predict the overall structure of the table 304 by identifying the number of rows and columns, which may be done by grouping cells based on their relative positions. The size of each cell (and therefore the row and column sizes) may also be determined by grouping the cells. Merged cells may also be identified by identifying cells whose boundaries do not align with the other cell boundaries in their respective rows and/or columns.

Once the input portion of the document 410 has been processed, the table structure recognition model 602 may analyze the geometric features (e.g., including their spatial relationships) to infer the structure of the table 304. Analyzing the geometric features may include tasks such as detecting table borders, identifying rows and columns, recognizing headers, and segmenting cell content. Analyzing the geometric features may utilize algorithms like image segmentation, object detection, and optical character recognition (OCR).

The table structure recognition model 602 may also or instead analyze the semantics features of the table 304. Analyzing the semantics features includes understanding the context and purpose of the table 304, recognizing data types (e.g., text, numerical values), inferring relationships between cells (e.g., identifying merged cells), rows, and columns, and the like. The table structure recognition model 602 may employ natural language processing techniques, domain-specific knowledge, or heuristics to aid in the semantic analysis.

Based on the analysis of the features of the table 304, the table structure recognition model 602 may generate a programmatic representation of the table 304. The programmatic representation may be a computer-readable language such as a HTML, JavaScript, Swift, and/or a customized domain-specific language. The output may include markup and/or tags to reconstruct the table 304 accurately, including table tags, row and column specifications, header labels, cell content, and/or merged cells (e.g., merged by width and/or height). The virtual table 604 may be represented so as to be able to allow for the recreation of the table 304 in a variety of applications (e.g., word processing applications, spreadsheet applications, and the like).

In some examples, the virtual table 604 may span the width and/or height of the table bounding box 504 of the cropped portion of the document 410 and rows, columns, and/or cells may be represented as percentages of the width and/or height of the table bounding box 504. In some examples, the virtual table 604 may be included as part of the document 410, such as in the form of metadata that is stored in association with the document 410.

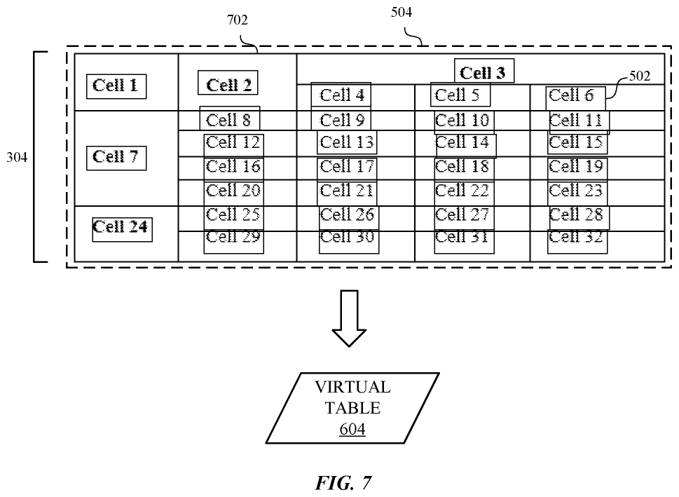

FIG. 7 depicts an example of mapping text data to the virtual table 604, in accordance with one or more implementations. As part of and/or separate from the analyses of table structure recognition model 602 as discussed above with respect to FIG. 6, the text of the cropped portion of the document 410 corresponding to the table bounding box 504 may be mapped to the virtual table 604. The virtual table 604 may be re-created and/or projected on the cropped portion of the document 410 corresponding to the table bounding box 504 according to the programmatic representation of the table 304 (e.g., the virtual table 604). The text (e.g., as identified in a bounding box 502) in each cell of the table 304 may be mapped to the corresponding cell of the re-created virtual table 702. The mapping may be performed computationally such that it is performed without displaying the virtual table 604 to the user. In one or more implementations, if a bounding box 502 of a text data overlaps multiple cells of the re-created virtual table 702, the text data of the bounding box 502 may be mapped to the cell of the re-created virtual table 702 with which it overlaps the most.

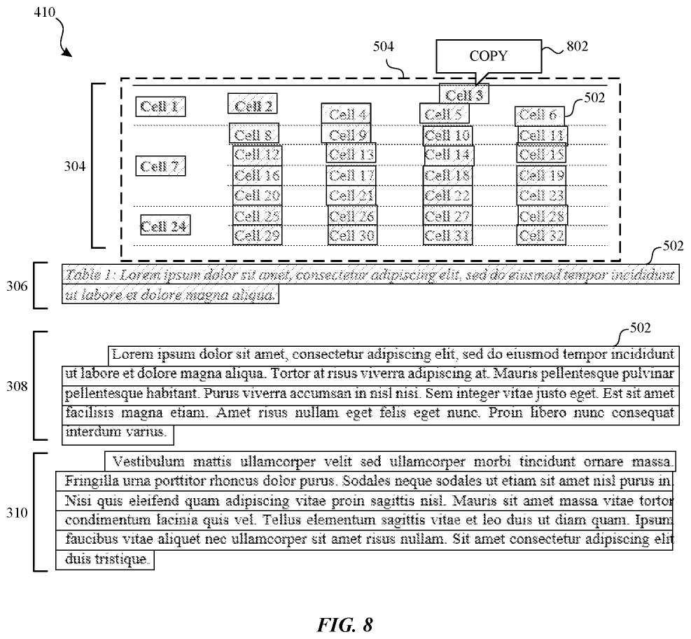

FIG. 8 depicts an example of copying text data including a table 304, in accordance with one or more implementations. The document 410 may include a virtual table 604 corresponding to the table 304, a table bounding box 504, and/or text bounding boxes 502, such as by having performed the operations discussed above with respect to FIGS. 5-7. The virtual table 604, table bounding box 504, and/or text bounding boxes 502 may be integrated with the document 410 and/or stored in association with the document 410 (e.g., as metadata in memory 204). In one or more implementations, the virtual table 604, table bounding box 504, and/or text bounding boxes 502 may be used to modify the text data when an operation is being performed with the text data.

For example, an operation may include a copy operation 802. A user may select portions of the text data, such as table 304 and paragraph 306, as shown by the shaded bounding boxes. The user may make a selection by touching, clicking, or generating any other input with the electronic device 102. The user may initiate the copy operation 802 by tapping, clicking, or generating any other input with the electronic device 102 on the selected text data, for example, and selecting the copy operation 802. When the copy operation 802 is initiated, the electronic device 102 may duplicate the selected text data to a clipboard (e.g., a buffer) such that data of the table 304 is stored as the virtual table 604.

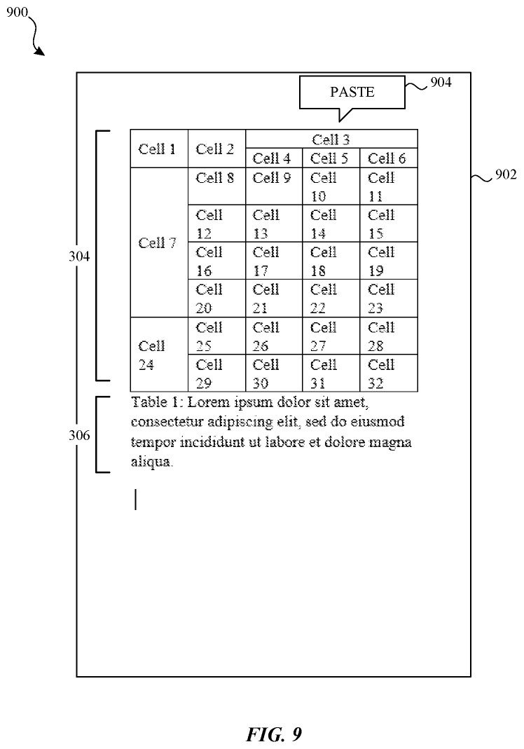

FIG. 9 depicts an example of pasting copied text data, in accordance with one or more implementations. In one or more implementations, the virtual table 604, table bounding box 504, and/or text bounding boxes 502 may be used to modify the text data when an operation is being performed with the text data. For example, an operation may include a paste operation 904. The copied data of FIG. 8 may be pasted in the same or different application, such as the application 900. For example, the application 900 may be a word processing application. To perform the paste operation 904, the user may change to an application 900 and tap, click, or generate any other input with the electronic device 102 on the application 900 (or one or more elements thereof) and select the paste operation 904. In a paste operation, the selected text data as shown in FIG. 8 may appear in the application 900 such that the table 304 and the paragraph 306 is formatted similar to the document 410. For example, the new document 902 in application 900 may include the table 304 having the same number of cells, including the same number of merged cells, and may include the paragraph 306 formatted as a single paragraph. In some examples, the pasted data is formatted such that the font, font size, and/or any other font attributes are also copied from the document 410. In some examples, the pasted table (e.g., table 304 in the new document 902) may include the grid lines (e.g., the lines defining the rows and columns), mirroring the grid lines of the copied table (e.g., the table 304 in the document 410).

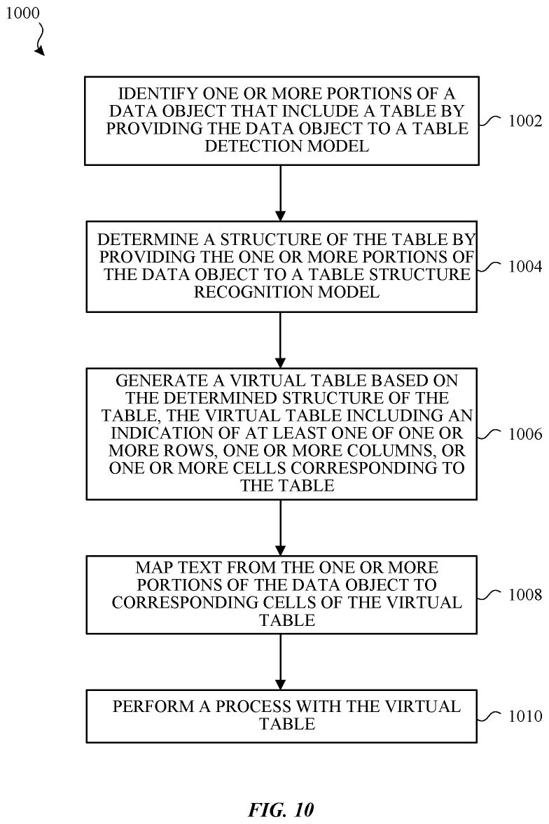

FIG. 10 depicts a flow diagram of an example process 1000 for processing text data including a table, in accordance with one or more implementations. For explanatory purposes, the process 1000 is primarily described herein with reference to the electronic device 102 of FIG. 1. However, the process 1000 is not limited to the electronic device 102, and one or more blocks of the process 1000 may be performed by one or more other components of the electronic device 102 and/or other suitable devices. Further, for explanatory purposes, the blocks of the process 1000 are described herein as occurring sequentially or linearly. However, multiple blocks of the process 1000 may occur in parallel. In addition, the blocks of the process 1000 need not be performed in the order shown and/or one or more blocks of the process 1000 need not be performed and/or can be replaced by other operations. In one or more implementations, an application stored on the electronic device 102 performs the process 1000 by calling APIs provided by the operating system of the electronic device 102. In one or more implementations, the operating system of the electronic device 102 performs the process 1000 by processing API calls provided by the application stored on the electronic device 102. In one or more implementations, the application stored on the electronic device 102 fully performs the process 1000 without making any API calls to the operating system of the electronic device 102.

At block 1002, the electronic device 102 may identify one or more portions of a data object (e.g., document 302) that include a table (e.g., the table 304). For example, the electronic device 102 may provide the data object to a table detection model (e.g., machine learning model 402) as input. The table detection model may generate, for one or more pixels of the data object, a likelihood (e.g., a percentage or confidence) that each pixel of the one or more pixels is part of a table (e.g., the table 304). With the pixel likelihoods, the table detection model may identify one or more candidate table regions of the data object (e.g., regions of the data object that likely include a table).

In some examples, the table detection model may include a backbone network (e.g., backbone network 404) and a table detection head (e.g., table detection head 408). The backbone network may be shared with a text detection head (e.g., text detection head 406). To train the table detection model, the backbone network and the text detection head may be trained first and then the table detection head may be trained separately. For example, one or more parameters of the backbone network and the text detection head may be modified and then one or more parameters of the table detection head may be modified without modifying the one or more parameters of the backbone network and the text detection head.

In some examples, the text detection head may generate one or more text bounding boxes (e.g., text bounding boxes 502) associated with the text in the data object. Each text bounding box may correspond to a line (e.g., a continuous string) of text data. For example, the paragraph 306 spans two lines, each of which may be covered by a text bounding box 502. As another example, each cell of the table 304 may include a line of text, and thus each cell of the table 304 may include a text bounding box 502.

In some examples, when the table detection model has identified candidate table regions in the data object, the table detection model may also generate a bounding box (e.g., the table bounding box 504) around the table corresponding to each candidate table region. Generating a table bounding box may include determining an orientation of one or more lines of text in a respective candidate table region. The orientation of the one or more lines of text may be based on their corresponding bounding boxes (e.g., the text bounding boxes 502).

Generating a table bounding box may also include determining an orientation of the respective candidate table region based on the orientation of the one or more lines of text in the respective candidate table region. For example, the orientation of the candidate table region may be the average of the orientations of the text bounding boxes. After determining the orientation of the respective candidate table region, a table bounding box may be generated based on the determined orientation and the respective candidate table region. The table bounding box may encompass a table in the candidate table region, and the table bounding box may represent the identified portion of the data object.

In some examples, a candidate table region may be rejected, and the table detection model may proceed to another candidate table region of the data object. For example, the candidate table region may be rejected if the amount of text in the candidate table region is below a threshold amount. As another example, the candidate table region may be rejected if its orientation deviates more than a threshold amount from the average orientation of one or more components of the data object (e.g., text bounding boxes and/or table bounding boxes).

At block 1004, the electronic device 102 may determine a structure of the table (e.g., the table 304). For example, the electronic device 102 may provide one or more identified portions of the data object to a table structure recognition model (e.g., table structure recognition model 602) as input. The one or more portions of the data object may include one or more portions of the data object corresponding to one or more table bounding boxes. The one or more portions of the data object may be extracted (e.g., cropped) from the data object. The one or more portions of the data object may also be normalized (e.g., rotated, transformed, aligned, shifted, and the like). The table structure recognition model may identify the number of rows and columns and the respective widths and heights, as well as any merged cells in the one or more portions of the data object. The table structure recognition model may also analyze the geometric and/or semantic features of the table, as described above with respect to FIG. 6.

At block 1006, the electronic device 102 may generate a virtual table (e.g., virtual table 604) based on the determined structure of the table. The output of the table structure recognition model may include a programmatic representation of the table as a virtual table. The virtual table may include an indication of one or more rows, one or more columns, and/or one or more cells corresponding to the table. In some examples, the row height and the column width may be represented as a percentage of a height and width, respectively, of the input portion of the data object.

At block 1008, the electronic device 102 may map text from the one or more portions of the data object to corresponding cells of the virtual table, as described above with respect to FIG. 7. To map the text to the virtual table, the virtual table may be provided (e.g., projected, re-created, etc.) on the one or more portions of the data object. The text in each cell of the table in the one or more portions of the data object may be mapped to the corresponding cell of the virtual table. The mapping may be performed computationally such that the mapping and providing are performed without displaying the virtual table to the user, for example, by calculating where a line of text is relative to the boundaries of the cells of the virtual table and mapping the line of text to the cell associated with the set of boundaries that are nearest to the line of text.

At block 1010, at least one process may be performed with the virtual table. In one or more implementations, a process may be a copy/paste operation, as described with respect to FIGS. 9-10. For example, a user may select one or more lines of text in a table and execute a copy operation (e.g., the copy operation 802) thereby copying the selection to a clipboard. The selection may be included in one or more cells of the table and copying the selection may include copying the virtual table and/or metadata indicating which parts of the virtual table were copied. When a paste operation (e.g., the paste operation 904) is performed, the selection may be pasted such that the selection is arranged in a table form as shown in the data object from which the selection was made. In some examples, only part of the table may be copied, in which case pasting the virtual table may include pasting the structure (e.g., cells) of the table but only the text of the selected portions of the table.

The selection may be pasted in any table format. For example, the selection may be pasted into a spreadsheet table format where pasting may include formatting and filling the cells of the spreadsheet according to the virtual table. The pasted table, including the text and/or the table structure, may be editable. For example, a user may replace and/or reformat the text in one or more cells. As another example, a user may add and/or remove rows and/or columns from the pasted table.

In one or more implementations, the virtual table may be provided to an application or a system process. An application or system process may access a file. For example, the virtual table may be written to a text file with table formatting applied, thereby generating a visual representation of the table. An application or system process may also or instead access a data structure. For example, the virtual table may be written to a buffer in memory. An application or system process may also or instead include a translation process. For example, a machine learning model trained to translate a first language to a second language may receive as input the virtual table including text data in the first language and output the text data in the second language.

An application or system process may also or instead include a dictation process. For example, the text data of the virtual table may correspond to text data in an audio format and be used as an input to a machine learning model trained to convert speech to text, where each text data in a cell is read with pauses between each cell. An application or system process may also or instead include a narration process. For example, the virtual table may be used as input to a machine learning model trained to convert text into an audio format in accordance with the virtual table, where the audio reads the text of each cell as a list, taking pauses between each cell, rather than reading each item continuously. An application or system process may also or instead include a virtual assistant process. For example, the virtual table may be used as part of a request to a virtual assistant that processes the request. In one or more implementations, the processes may be incorporated with one another. For example, the narration process may receive the virtual table for narration and pass it to the audio generation process to generate an audio file for narrating the text data corresponding to the virtual table.

FIG. 11 depicts an example electronic system 1100 with which aspects of the present disclosure may be implemented, in accordance with one or more implementations. The electronic system 1100 can be, and/or can be a part of, any electronic device for generating the features and processes described in reference to FIGS. 1-10, including but not limited to a laptop computer, tablet computer, smartphone, and wearable device (e.g., smartwatch, fitness band). The electronic system 1100 may include various types of computer-readable media and interfaces for various other types of computer-readable media. The electronic system 1100 includes one or more processing unit(s) 1114, a persistent storage device 1102, a system memory 1104 (and/or buffer), an input device interface 1106, an output device interface 1108, a bus 1110, a ROM 1112, one or more processing unit(s) 1114, one or more network interface(s) 1116, and/or subsets and variations thereof.

The bus 1110 collectively represents all system, peripheral, and chipset buses that communicatively connect the numerous internal devices of the electronic system 1100. In one or more implementations, the bus 1110 communicatively connects the one or more processing unit(s) 1114 with the ROM 1112, the system memory 1104, and the persistent storage device 1102. From these various memory units, the one or more processing unit(s) 1114 retrieves instructions to execute and data to process in order to execute the processes of the subject disclosure. The one or more processing unit(s) 1114 can be a single processor or a multi-core processor in different implementations.

The ROM 1112 stores static data and instructions that are needed by the one or more processing unit(s) 1114 and other modules of the electronic system 1100. The persistent storage device 1102, on the other hand, may be a read-and-write memory device. The persistent storage device 1102 may be a non-volatile memory unit that stores instructions and data even when the electronic system 1100 is off. In one or more implementations, a mass-storage device (such as a magnetic or optical disk and its corresponding disk drive) may be used as the persistent storage device 1102.

In one or more implementations, a removable storage device (such as a floppy disk, flash drive, and its corresponding disk drive) may be used as the persistent storage device 1102. Like the persistent storage device 1102, the system memory 1104 may be a read-and-write memory device. However, unlike the persistent storage device 1102, the system memory 1104 may be a volatile read-and-write memory, such as RAM. The system memory 1104 may store any of the instructions and data that one or more processing unit(s) 1114 may need at runtime. In one or more implementations, the processes of the subject disclosure are stored in the system memory 1104, the persistent storage device 1102, and/or the ROM 1112. From these various memory units, the one or more processing unit(s) 1114 retrieves instructions to execute and data to process in order to execute the processes of one or more implementations.

The bus 1110 also connects to the input device interfaces 1106 and output device interfaces 1108. The input device interface 1106 enables a user to communicate information and select commands to the electronic system 1100. Input devices that may be used with the input device interface 1106 may include, for example, alphanumeric keyboards, touch screens, and pointing devices (also called “cursor control devices”). The output device interface 1108 may enable, for example, the display of images generated by electronic system 1100. Output devices that may be used with the output device interface 1108 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 11, the bus 1110 also couples the electronic system 1100 to one or more networks and/or to one or more network nodes through the one or more network interface(s) 1116. In this manner, the electronic system 1100 can be a part of a network of computers (such as a LAN, a wide area network (“WAN”), an Intranet, or a network of networks, such as the Internet). Any or all components of the electronic system 1100 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

As described above, one aspect of the present technology is the gathering and use of data available from specific and legitimate sources for processing text data. The present disclosure contemplates that in some instances, this gathered data may include personal information data that uniquely identifies or can be used to identify a specific person. Such personal information data can include demographic data, location-based data, online identifiers, telephone numbers, email addresses, home addresses, images, videos, audio data, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for processing text data. Accordingly, the use of such personal information data may facilitate transactions (e.g., online transactions). Further, other uses for personal information data that benefit the user are also contemplated by the present disclosure. For instance, health and fitness data may be used, in accordance with the user's preferences to provide insights into their general wellness or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of processing text data, the present technology can be configured to allow users to select to “opt-in” or “opt-out” of participation in the collection of personal information data during registration for services or anytime thereafter. In addition to providing “opt-in” and “opt-out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data.

What is claimed is:

1. A method comprising:
identifying one or more portions of a data object that include a table by providing the data object to a table detection model;
determining a structure of the table by providing the one or more portions of the data object to a table structure recognition model;
generating a virtual table based on the determined structure of the table, the virtual table including an indication of at least one of one or more rows, one or more columns, or one or more cells corresponding to the table;
mapping text from the one or more portions of the data object to corresponding cells of the virtual table; and
performing a process with the virtual table.

2. The method of claim 1, wherein the table detection model includes a backbone network associated with a text detection head and a table detection head.

3. The method of claim 2, further comprising, before providing the data object to the table detection model:
modifying one or more parameters of the backbone network and the text detection head; and
modifying one or more parameters of the table detection head without modifying the one or more parameters of the backbone network and the text detection head.

4. The method of claim 2, wherein identifying the one or more portions of the data object comprises:
generating one or more bounding boxes around text included in the one or more portions of the data object; and
providing the one or more bounding boxes to the table structure recognition model.

5. The method of claim 1, wherein identifying the one or more portions of the data object comprises:
generating, for one or more pixels of the data object, a likelihood that each pixel of the one or more pixels is part of a table; and
identifying one or more candidate table regions of the data object based on the generated likelihoods.

6. The method of claim 5, wherein identifying the one or more portions of the data object comprises:
determining an orientation of one or more lines of text in a respective candidate table region of the one or more candidate table regions;
determining an orientation of the respective candidate table region based on the orientation of one or more lines of text; and
generating a bounding box based on the respective candidate table region and the determined orientation, the bounding box representing an identified portion of the data object.

7. The method of claim 6, further comprising:
rejecting the respective candidate table region, in response to a determination that an amount of text in the identified portion of the data object is below a threshold amount of text; and
rejecting the respective candidate table region, in response to a determination that the determined orientation deviates more than a threshold amount from an average orientation of the one or more portions of the data object.

8. The method of claim 1, wherein providing the one or more portions of the data object to the table structure recognition model comprises:
extracting the one or more portions of the data object from the data object; and
normalizing the extracted one or more portions of the data object.

9. The method of claim 1, wherein the structure of the table comprises one or more of a number of rows, a number of columns, a row height, a column width, or indications of merged cells.

10. The method of claim 9, wherein the row height and the column width are a percentage of a height and width, respectively, of the one or more portions of the data object.

11. The method of claim 1, wherein mapping text from the one or more portions of the data object to corresponding cells of the virtual table comprises:
providing the virtual table on the one or more portions of the data object; and
mapping text in each cell of the table in the one or more portions of the data object to the corresponding cell of the virtual table.

12. The method of claim 1, wherein performing a process with the virtual table comprises:
providing the virtual table to the process for generating a visual representation of the table.

13. A device comprising:
a memory; and
a processor configured to:
identify one or more portions of a data object that include a table by providing the data object to a table detection model;
determine a structure of the table by providing the one or more portions of the data object to a table structure recognition model;
generate a virtual table based on the determined structure of the table, the virtual table including an indication of at least one of one or more rows, one or more columns, or one or more cells corresponding to the table;
map text from the one or more portions of the data object to corresponding cells of the virtual table; and
performing a process with the virtual table.

14. The device of claim 13, wherein the table detection model includes a backbone network associated with a text detection head and a table detection head.

15. The device of claim 14, wherein the processor is further configured to, before providing the data object to the table detection model:
modify one or more parameters of the backbone network and the text detection head; and
modify one or more parameters of the table detection head without modifying the one or more parameters of the backbone network and the text detection head.

16. The device of claim 14, wherein identifying the one or more portions of the data object comprises:
generating one or more bounding boxes around text included in the one or more portions of the data object; and
providing the one or more bounding boxes to the table structure recognition model.

17. The device of claim 13, wherein identifying the one or more portions of the data object comprises:
generating, for one or more pixels of the data object, a likelihood that each pixel of the one or more pixels is part of a table; and
identifying one or more candidate table regions of the data object based on the generated likelihoods.

18. The device of claim 17, wherein identifying the one or more portions of the data object comprises:
determining an orientation of one or more lines of text in a respective candidate table region of the one or more candidate table regions;
determining an orientation of the respective candidate table region based on the orientation of one or more lines of text; and
generating a bounding box based on the respective candidate table region and the determined orientation, the bounding box representing an identified portion of the data object.

19. The device of claim 18, wherein the processor is further configured to:
reject the respective candidate table region, in response to a determination that an amount of text in the identified portion of the data object is below a threshold amount of text; and
reject the respective candidate table region, in response to a determination that the determined orientation deviates more than a threshold amount from an average orientation of the one or more portions of the data object.

20. A non-transitory computer-readable medium comprising computer-readable instructions that, when executed by a processor, cause the processor to perform one or more operations comprising:
identifying one or more portions of a data object that include a table by providing the data object to a table detection model;
determining a structure of the table by providing the one or more portions of the data object to a table structure recognition model;
generating a virtual table based on the determined structure of the table, the virtual table including an indication of at least one of one or more rows, one or more columns, or one or more cells corresponding to the table;
mapping text from the one or more portions of the data object to corresponding cells of the virtual table; and
performing a process with the virtual table.
